(19) United States
(12) Patent Application Publication
(10) Pub. No.: US 2026/0264312 A1
(43) Pub. Date: Sep. 10, 2026

(54) A stretchable layer for a reconfigurable mold, a stretchable heating blanket, a membrane, an apparatus for making a three-dimensionally curved object, and a stretchable layer fabrication method

(71) Applicant: Curve Works Holding B.V., Hazerswoude-Rijndijk (NL)

(72) Inventor: Francois Geuskens, Hazerswoude-Rijndijk (NL)

(21) Appl. No.: 18/847,066

(22) PCT Filed: Mar. 15, 2023
(86) PCT No.: PCT/NL2023/050132

§ 371 Date: Sep. 13, 2024

(30) Foreign Application Priority Data
Mar. 15, 2022 (NL) 2031298
Jul. 27, 2022 (NL) 2032624

(51) Int. Cl. B29C 51/42; B29C 33/50; B29C 51/30

(52) U.S. Cl. CPC B29C 51/428; B29C 33/50; B29C 51/30

(57) ABSTRACT

The invention relates to a stretchable layer for a reconfigurable mold comprising one or more embedded heating elements (5), each heating element (5) having a heating wire (6) for generating heat, characterized in that the heating wire (6) forms an elongated shape around a longitudinal axis, wherein a length of the shape corresponds to a length of the longitudinal axis, wherein a width of the shape is defined as a dimension of the shape perpendicular to the longitudinal axis in-plane of the stretchable layer, wherein a thickness of the shape is defined as a dimension of the shape perpendicular to the longitudinal axis out-of-plane of the stretchable layer, and wherein the shape is composed of x and y-components, in which x and y are directions in a Cartesian coordinate system with x being a direction corresponding to a width of the shape and y being a direction corresponding to a thickness of the shape, and in which the y-component of the shape is a substantially meandering (2D) pattern.

### BACKGROUND OF THE INVENTION

The invention relates to a stretchable layer for a reconfigurable mold. The invention further relates to a reconfigurable mold and method for operating a reconfigurable mold.

A reconfigurable mold provides a dynamically reconfigurable surface for use in thermoforming objects, laminating objects or casting objects having a curved or double-curved shape. The main advantage of a reconfigurable mold over shaping a mold from a block using CNC machining is that there is less waste of both energy and materials.

Thermoforming objects requires the application of heat and pressure to form materials above their glass transition temperature. The application of heat can also be required when thermoset resins are used to laminate or cast objects to aid the curing process. Possible ways to apply heat for a reconfigurable mold currently include mounting an infrared heater above the reconfigurable mold, building a convection oven around the reconfigurable mold, or applying a stretchable heating blanket.

Because heat is preferably applied as locally as possible to reduce energy consumption and increase efficiency, the stretchable heating blanket would currently be the preferred option for a reconfigurable mold.

However, when using prior art stretchable heating blankets with a reconfigurable mold, the applicant found that the elongation of stretchable heating blankets is insufficient, in other words prior art heating blankets are easily overstretched resulting in internal damage, and that stretchable heating blankets are not able to uniformly apply heat in all configurations of a reconfigurable mold and that even hot spots may occur resulting in undesired high risk of causing ignition of materials.

Embedding heating elements into a polymer mold that is attached to a set of pins by a set of ball joints, wherein actuating linear motion of the set of pins allows to deform the mold into a three-dimensional geometric shape that includes 3D curves, as disclosed in U.S. Pat. No. 11,001,016B2, does not solve the limited elongation, the issue of uniformly applying heat or reducing the risk of hot spots.

Although 2D meandering patterns of the heating elements, i.e. a meandering pattern in plane of the stretchable layer parallel to a top surface of the reconfigurable mold, have been proposed in the prior art, see for instance US2020/331214A1, WO2017/166955A1 and RU2254997C1, the abovementioned problems still remain at least to some undesirable extent.

The abovementioned problems increase when reconfigurable molds are used to achieve more extreme curvatures of the object to be molded.

### SUMMARY OF THE INVENTION

In view of the above it is an object of the invention to provide a stretchable layer for a reconfigurable mold that is able to conform to all shapes the reconfigurable mold can generate and that is able to more uniformly apply heat to the mold.

According to a first aspect of the invention, there is provided a stretchable layer for a reconfigurable mold comprising one or more embedded heating elements, each heating element having a heating wire for generating heat, characterized in that the heating wire forms an elongated shape around a longitudinal axis, said longitudinal axis extending in-plane of the stretchable layer, wherein a length of the shape corresponds to a length of the longitudinal axis, wherein a width of the shape is defined as a dimension of the shape perpendicular to the longitudinal axis in-plane of the stretchable layer, wherein a thickness of the shape is defined as a dimension of the shape perpendicular to the longitudinal axis out-of-plane of the stretchable layer, and wherein the shape is composed of x and y-components, in which x and y are directions in a Cartesian coordinate system with x being a direction corresponding to a width of the shape and y being a direction corresponding to a thickness of the shape, and in which the y-component of the shape is a substantially meandering pattern.

The invention according to the first aspect of the invention is based on the insight of the inventor(s) that a reconfigurable mold may result in in-plane deformations of the stretchable layer in different directions, and that an out-of-plane meandering pattern is able to minimize the effect the presence of the heating wire has on the stretchable layer. When using 2D in-plane meandering patterns, as is currently done in the prior art, there will always be an in-plane deformation direction that is parallel to a relatively large heating wire portion. This heating wire portion may be inflexible compared to the surrounding material thereby providing a relatively large resistance to the deformation causing stress on the interface between the heating wire portion and the surrounding material and causing relatively large deformations of surrounding material to compensate for the inflexible heating wire portion. The stress at the interface between heating wire portion and surrounding material may become so large that the heating wire portion acts like a cutting wire thereby damaging the surrounding material. With the shape as proposed in the first aspect of the invention, the heating wire is able to more easily bend and twist allowing to deform its shape along with the desired deformation of the stretchable layer.

A Cartesian coordinate system is used to describe different directions of the shape and includes an x-direction, a y-direction and a z-direction that are orthogonal to each other. The orientation of the Cartesian coordinate system depends on the shape formed by the heating wire and thus may vary along the longitudinal axis of the shape. The z-direction at a specific location is tangent to the longitudinal axis of the shape with the x-direction corresponding to a width direction of the shape in-plane of the stretchable layer and the y-direction corresponding to a thickness direction of the shape out-of-plane of the stretchable layer. The x-component of the shape is then the projection of the shape onto an xz-plane of the Cartesian coordinate system, and the y-component is then the projection of the shape onto a yz-plane of the Cartesian coordinate system.

The y-component being a substantially meandering pattern has the advantage that the heating wire extends through the stretchable layer in a manner in which a longitudinal axis of the heating wire itself is in-plane of the stretchable layer for only a relatively small portion of the entire length of the heating wire. Hence, upon deformation of the stretchable layer, the shape formed by the heating wire is able to adjust its length by bending and/or twisting of the heating wire which can be significantly longer than by elongation of the heating wire.

A meandering pattern may be defined by a pattern including a series of bends, loops, turns or windings. A meandering pattern may be regular in which a pattern portion is repeated or irregular like the meander of a river.

The shape formed by the heating wire may be a 2D-shape in which the heating wire is in a single plane, i.e. the dimension of the shape in one direction is substantially equal to a dimension of the heating wire itself. However, it is explicitly noted that this 2D-shape compared with the meandering 2D-shapes used in the prior art are at an non-zero angle relative to each other. This is for instance the case when the x-component of the shape has a constant value-resulting in a shape extending in a plane perpendicular to the plane of the stretchable layer- or when the x-component of the shape is identical to the y-component of the shape, possibly except for a difference in amplitude-resulting in a shape extending in a tilted plane that is non-parallel to both the xz-and yz-plane.

In an embodiment, the x-component of the shape is a meandering pattern. As mentioned above when the meandering patterns are identical, possibly except for a difference in amplitude, this may result in a 2D-shape formed by the heating wire.

In an embodiment, the meandering patterns of the x-component and/or the y-component are periodic functions, e.g. sinusoidal. In this case, when the periodic functions are similar (same spatial period) and the phase shift between the meandering patterns is either zero or 180 degrees, this also results in a 2D shape.

In an embodiment, any other shift between two similar meandering patterns relative to each other will result in a 3D-shape formed by the heating wire. The phase shift may be 90 degrees. When using phase shifts in this specification, a single valued phase shift a in general means a modulo 180 degrees, unless specifically stated otherwise.

Hence, in an embodiment, the x-component of the shape and the y-component of the shape are similar meandering patterns shifted relative to each other.

In an embodiment, the meandering patterns both have the same amplitude.

In the specific case that both the x-component and the y-component are sinusoidal having the same spatial period, a phase shift of 90 degrees, and the same amplitude, the shape formed by the heating wire is helical, which may alternatively be referred to as a coil shape with a circular cross-section.

Hence, in an embodiment, the meandering patterns of the x-component and the y-component are periodic functions, preferably having the same spatial period.

Further, in an embodiment, the meandering patterns are periodic functions with a phase shift of substantially 90 degrees.

The above features describe internal characteristics of the shape relative to its longitudinal axis. The longitudinal axis itself may be a straight line in-plane of the stretchable layer or may meander in-plane of the stretchable layer as well as is known from the prior art.

In an embodiment, the one or more heating elements are resilient, e.g. behave similar to extension springs. The heating wires of the one or more embedded heating elements may comprise spring steel.

In an embodiment, the one or more heating elements include a first set of heating elements and a second set of heating elements to be controlled independently from each other.

In an embodiment, the first set of heating elements and the second set of heating elements overlap at least partially.

In an embodiment, the 3D shape formed by the heating wire has a core made of the same material as the material surrounding the 3D shape.

In an embodiment, the 3D shape formed by the heating wire has a coil-like shape with a pitch that is smaller than a width and/or thickness of the 3D shape, preferably smaller than 10 mm, more preferably smaller than 5 mm, and most preferably smaller than 3 mm.

According to a second aspect of the invention, there is provided a stretchable heating blanket for a reconfigurable mold comprising a stretchable layer according to the first aspect of the invention.

According to a third aspect of the invention, there is provided a membrane for a reconfigurable mold, said membrane having a stretchable or conformable molding surface and comprising a stretchable layer according to the first aspect of the invention for heating the molding surface.

In an embodiment, reinforcement rods are provided in tubes embedded in a reinforcement layer of the membrane, and wherein the stretchable layer is arranged between the reinforcement layer and the molding surface.

According to a fourth aspect of the invention, there is provided an apparatus for making a three-dimensionally curved object, said apparatus comprising a membrane according to the third aspect of the invention, said membrane having a molding surface, and said apparatus further comprising an array of actuators for directly or indirectly acting on a surface opposite the molding surface of the membrane, wherein the apparatus is configured such that the membrane is configurable into a predetermined shape by individually adjusting an array of actuators acting on the surface opposite the molding surface of said membrane.

According to a fifth aspect of the invention, there is provided a method for fabricating a stretchable layer according to the first aspect of the invention, said method comprising the following steps:
a) preparing a mold for the stretchable layer,
b) positioning one or more heating elements with the corresponding heating wires in a desired shape in the mold,
c) filling the mold with a resin to embed the one or more heating elements in the resin, and
d) curing the resin.

In an embodiment, a semi-fabricated membrane is arranged in the mold such that the one or more heating elements are arranged on top of the semi-fabricated membrane, such that a stretchable layer including embedded one or more heating elements is added on top of the semi-fabricated membrane, preferably forming a molding surface.

In an embodiment, the one or more heating elements of the stretchable layer are configured to behave similar to extension springs, wherein preferably in step b. the one or more heating elements are positioned in the mold using a predetermined tension resulting in a predetermined extension of the one or more heating elements. The predetermined tension may result in an extension of 1-10 mm/m of the elongated shape, preferably an extension of 2-5 mm/m.

Features and/or embodiments described in relation to one aspect of the invention may readily be applied to any other aspect of the invention, where appropriate.

### BRIEF DESCRIPTION OF THE DRAWINGS

The invention will now be described in a non-limiting way by reference to the accompanying drawings in which like parts are indicated by like reference symbols, and in which:

FIG. 1 schematically depicts a perspective view of a molding tool for making a three-dimensional object,

FIG. 2 schematically depicts a perspective view of a membrane according to an embodiment of the invention,

FIG. 3 schematically depicts a detailed cross-sectional view of the membrane of FIG. 2,

FIG. 4 schematically depicts a 2D shape with a meandering y-component and constant x-component,

FIG. 5 schematically depicts a 2D shape with a meandering y-component and a meandering x-component,

FIG. 6 schematically depicts a 3D shape with a meandering y-component and a meandering x-component,

FIG. 7 schematically depicts a top view of a membrane according to a further embodiment of the invention,

FIG. 8 schematically depicts a connection configuration of heating elements of the membrane of FIG. 7,

FIG. 9 schematically depicts a top view of a membrane according to yet another embodiment of the invention,

FIG. 10 schematically depicts a connection configuration of heating elements of the membrane of FIG. 9, and

FIG. 11 schematically depicts a top view of a membrane according to an embodiment of the invention.

### DETAILED DESCRIPTION OF THE INVENTION

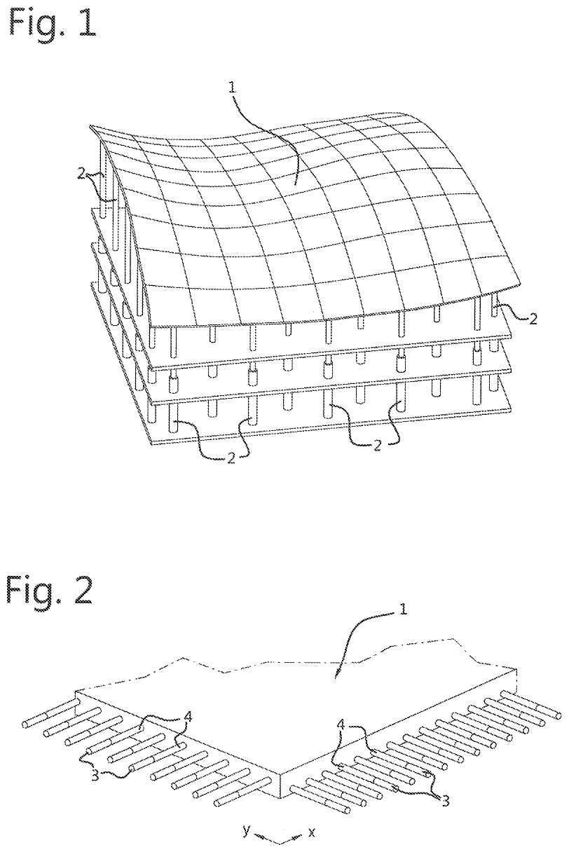

FIG. 1 schematically depicts an apparatus for molding a three-dimensional object. The apparatus may be used as one part of a double-sided molding tool. The apparatus includes a membrane 1 which is supported by an array of actuators 2. The actuators 2 all have the same orientation in FIG. 1 although this does not necessarily have to be the case in other embodiments. The orientation of the actuators 2 is substantially perpendicular to the membrane 1 and in this case may be referred to as a vertical orientation. The actuators 2 are individually adjustable in length to deflect the membrane 1 into a curved shape, e.g. a single-curved or double-curved shape. In other words, the actuators 2 may be configured to provide a three-dimensional shape to the membrane 1 as for instance shown in FIG. 1.

The actuators 2 may be linear actuators to be controlled by a control system (not shown) for setting the individual lengths of the actuators 2 in accordance with a predetermined membrane shape.

The distal ends of the actuators 2 may be fixed to the underside of the membrane 1 resulting in a conformable molding surface as for instance disclosed in WO2012/065614. Alternatively, the membrane 1 may be made of ferromagnetic material and the distal ends of the actuators 2 may be provided with a magnetic joint system allowing the joints holding the membrane 1 to slide on the holding surface (the not visible underside of the membrane 1 in FIG. 1) resulting in a conformable and stretchable molding surface as for instance disclosed in WO2017/153319.

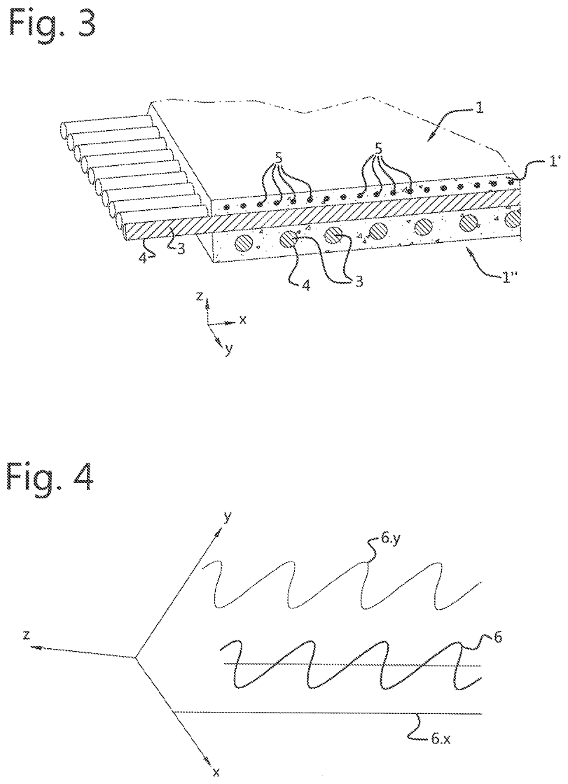

FIGS. 2 and 3 depict a membrane 1 suitable to be used in an apparatus as shown in FIG. 1. In this embodiment, the membrane 1 is provided with two sets of rods 3, e.g. carbon rods 3, wherein the sets of carbon rods 3 intersect with substantially perpendicular angle to each other (see for instance FIG. 2). In each set, the rods 3 are provided with a small spacing in between them and provided in tubes 4. The tubes 4 are embedded in the membrane 1 to produce a uniform connection between the tubes 4 and rods 3 accommodated therein. The tubes 4 provide flexibility in compression and tension of the whole membrane 1, which otherwise would be restricted by the rods 3 inability to extend and compress relative to the membrane 1.

As clearly visible in FIG. 3, the membrane 1 includes a top layer 1′ which serves the purpose of providing a smooth or otherwise predetermined molding surface of the membrane 1.

When the membrane 1 is attached to the actuators 2 with the aforementioned magnetic joint system, the membrane 1 may also be provided with a friction-reducing surface layer 1″ on the membrane side opposite the molding surface. This has the advantage that the magnetic holding joints can slide relative to the membrane 1 whilst holding the membrane 1 in a predetermined shape or during the deformation of the membrane 1 into a predetermined shape.

The top layer 1′ in this embodiment comprises a plurality of heating elements for heating the molding surface, so that the heating elements 5 are arranged between the rods 3 and the molding surface provided by the top layer 1′. Each heating element has a heating wire for generating heat. Different embodiments of the shape of the heating wires will be described below by reference to the FIGS. 4-6 using a coordinate system described in relation to FIG. 3.

FIG. 3 also shows the two sets of rods 3, wherein a first set of rods 3 extends substantially parallel to the plane of drawing, and wherein a second set of rods 3 extends below the first set of rods substantially perpendicular to the plane of drawing. In this embodiment, the heating elements 5 extend parallel to the second set of rods 3. A Cartesian coordinate system is defined including x, y and z directions. The z-direction is defined as being parallel to a direction tangent to a longitudinal axis of the heating elements, i.e. corresponding to a length of the shape of the heating wire. As the heating elements in this embodiment are straight, the z-direction is parallel to the longitudinal axis along the entire length of the heating elements. The x-direction is a direction corresponding to a width (in-plane) of the shape of the heating wire, and the y-direction is a direction corresponding to a thickness (out-of-plane) of the shape of the heating wire. As a result thereof, the longitudinal axis also extends in-plane.

FIG. 4 schematically depicts a portion of a heating wire 6 according to an embodiment of the invention. The shape of the heating wire 6 advances in the z-direction, which shape can be defined by its x-component 6.x and its y-component 6.y. In the embodiment of FIG. 4, the x-component is a constant value, and the y-component is meandering resulting in a 2D shape of the heating wire in a plane having a normal extending in a direction parallel to the x-direction.

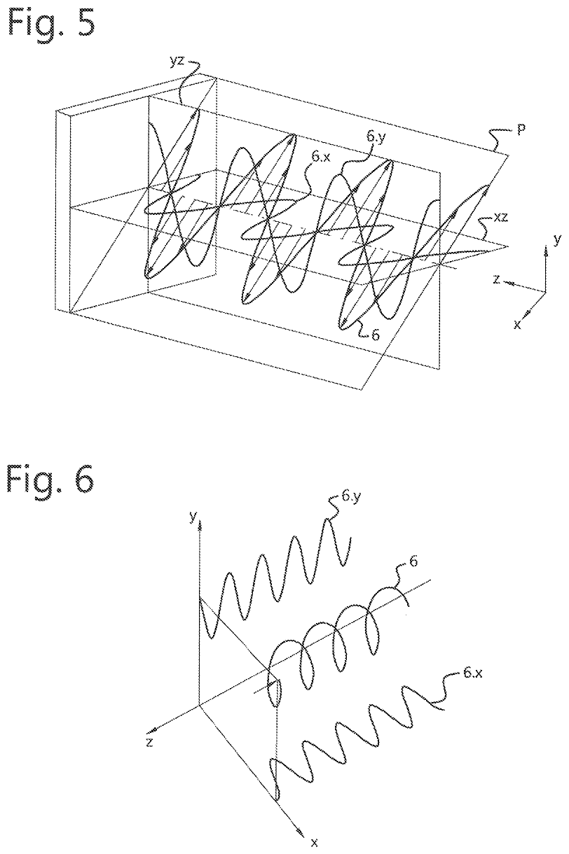

FIG. 5 schematically depicts a portion of a heating wire 6 according to another embodiment of the invention. The shape of the heating wire 6 advances in the z-direction, which shape can be defined by its x-component 6.x and its y-component 6.y.

The x-component 6.x is depicted in the xz-plane while the y-component is depicted in the yz-plane. In the embodiment of FIG. 5, both the x-component and the y-component have a meandering pattern with equal phase, amplitude, and frequency, resulting in a 2D shape of the heating wire in a plane P making a 45 degrees angle with the yz-plane (and thus also making a 45 degrees angle with the xz-plane.

FIG. 6 schematically depicts a portion of a heating wire 6 according to a further embodiment of the invention. The shape of the heating wire 6 advances in the z-direction, which shape can be defined by its x-component 6.x and its y-component 6.y. In the embodiment of FIG. 6, both the x-component and the y-component have a meandering pattern with equal amplitude and frequency, but with a phase shift of 90 degrees, resulting in a 3D shape of the heating wire, namely a helical shape like a spring.

In the examples of FIGS. 4-6, the meandering patterns are periodic functions such as sinusoidal functions as the sine and cosine. However, this is not necessary per se.

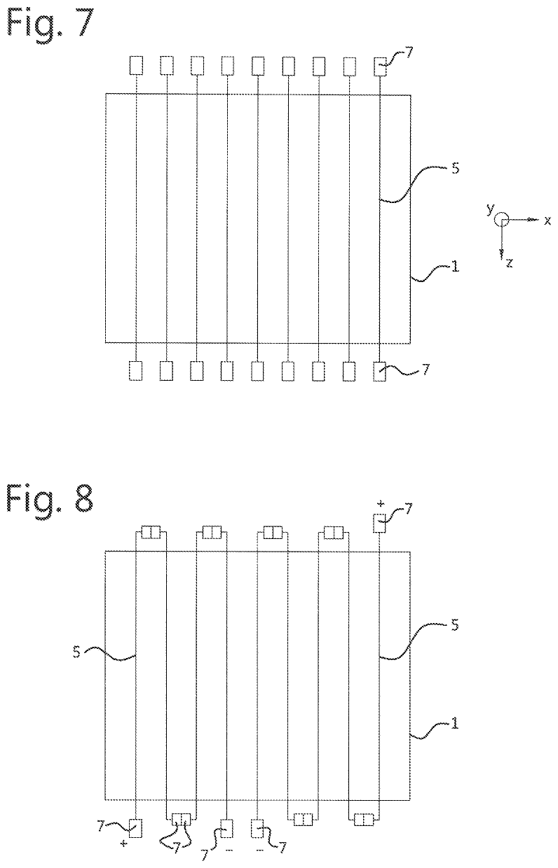

FIG. 7 schematically depicts a membrane 1 for use in for instance an apparatus as disclosed in FIG. 1. The membrane comprises a stretchable layer with one or more embedded heating elements 5 of which only one is indicated using reference numeral “5”. Each heating element 5 includes a heating wire for generating heat.

The heating wires each form an elongated shape around a longitudinal axis extending in z-direction. A length of the shape, opposed to the length of the heating wire, is defined as a length of the longitudinal axis. A width of the shape is defined as a dimension of the shape perpendicular to the longitudinal axis in-plane of the stretchable layer, in this case in x-direction. A thickness of the shape is defined as a dimension of the shape perpendicular to the longitudinal axis out-of-plane of the stretchable layer, in this case in y-direction. With the x-direction being a direction corresponding to a width of the shape and the y-direction being a direction corresponding to a thickness of the shape, the shape can be described based on a y-component, which is the projection of the shape on the yz-plane, and an x-component, which is the projection of the shape on the xz-plane, wherein at least the y-component of the shape is a substantially meandering pattern, for instance as shown in FIGS. 4-6.

In the embodiment of FIG. 7, the heating elements 5 extend beyond the membrane 1 at both sides of the membrane 1. At the free ends of the heating elements 5, connectors 7 are provided allowing to connect the free ends of the heating elements 5 together, thereby arranging the heating elements 5 in series, or to connect the free ends of the heating element to a power and control system for applying an electrical current for heating purposes. The free ends with the connectors provide flexibility in which heating elements are used and simultaneously controlled. When all heating elements are provided with free ends and connectors 7, as in FIG. 7, maximum flexibility is obtained. However, it is also possible that the connectors are only provided at certain locations, depending on the use cases of the corresponding apparatus or molding tool.

FIG. 8 provides a possible connection configuration of the membrane 1 of FIG. 7. In this connection configuration, the four left most heating elements 5 are grouped together to form a first subset of heating elements 5 that is connected and thus controlled by a first power and control system as indicated by the “+” and “−” reference symbols at the first and last connector 7 of the first subset.

The five right most heating elements 5 are also grouped together to form a second subset of heating elements 5 that is connected and thus controlled by a second power and control system as indicated by the “+” and “−” reference symbols at the first and last connector 7 of the second subset.

An advantage is that when only a part of the molding surface is used, e.g. the part above the second subset of heating elements 5, only heat is generated on that part and no energy is wasted in the membrane part corresponding to the first subset of heating elements 5. It is also possible that both subsets are used simultaneously but controlled to different temperatures.

FIG. 9 schematically depicts a membrane 1 for use in for instance an apparatus as disclosed in FIG. 1. The membrane comprises a stretchable layer with one or more embedded heating elements 5 of which only two are indicated using reference numeral “5”. Each heating element 5 includes a heating wire for generating heat.

The heating wires each form an elongated shape around a longitudinal axis mainly extending in z-direction. A length of the shape, opposed to the length of the heating wire, is defined as a length of the longitudinal axis. A width of the shape is defined as a dimension of the shape perpendicular to the longitudinal axis in-plane of the stretchable layer, in this case in x-direction. A thickness of the shape is defined as a dimension of the shape perpendicular to the longitudinal axis out-of-plane of the stretchable layer, in this case in y-direction. With the x-direction being a direction corresponding to a width of the shape and the y-direction being a direction corresponding to a thickness of the shape, the shape can be described based on a y-component, which is the projection of the shape on the yz-plane, and an x-component, which is the projection of the shape on the xz-plane, wherein at least the y-component of the shape is a substantially meandering pattern, for instance as shown in FIGS. 4-6.

In the embodiment of FIG. 9, each heating element has two halves that are arranged next to each other and connected to each other near a center line CL of the membrane 1. The free ends of the heating element thus extend beyond the membrane at the same side of the membrane and are provided with connectors 7 allowing to connect the free ends of adjacent heating elements 5 together, thereby arranging the heating elements 5 in series, or to connect the free ends of the heating element to a power and control system for applying an electrical current for heating purposes. When all heating elements are provided with free ends and connectors 7, as in FIG. 9, maximum flexibility is obtained. However, it is also possible that the connectors are only provided at certain locations, depending on the use cases of the corresponding apparatus or molding tool.

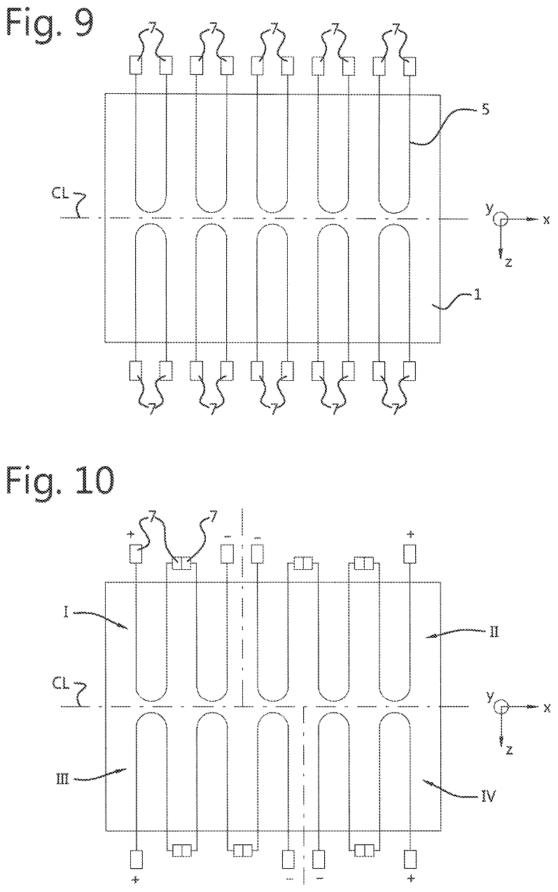

An advantage of the embodiment of FIG. 9 over the embodiment of FIG. 7 is that not only subsets can be made in x-direction, but also in y-direction allowing for instance a connection configuration as depicted in FIG. 10 in which different subsets result in four sections I, II, III, IV of the membrane 1 that are individually controllable. To this end, connectors 7 of adjacent heating elements are connected to each other and the first and last connector of a subset are connected to a power and control system as indicated by the “+” and “−” reference symbols.

FIG. 10 schematically depicts a membrane 1 for use in for instance an apparatus as disclosed in FIG. 1. The membrane 1 comprises a stretchable later with a plurality of embedded heating elements. Each heating element includes a heating wire for generating heat.

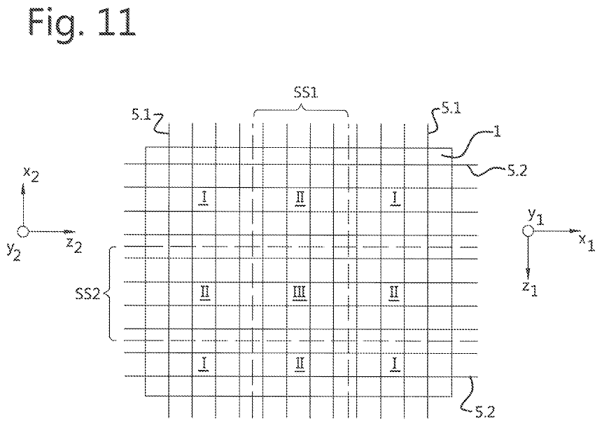

The plurality of heating elements includes a first set of heating elements 5.1 and a second set of heating elements 5.2. Of the first set of heating elements 5.1, only the left most and right most heating element in FIG. 11 have been indicated using reference symbol 5.1. Of the second set of heating elements 5.2, only the top and bottom heating element in FIG. 11 have been indicated using reference symbol 5.2.

The heating elements 5.1 of the first set of heating elements all extend parallel to each other in a z1-direction. The heating wires of the heating elements 5.1 each form an elongated shape around a longitudinal axis extending in z1-direction. A length of the shape, opposed to the length of the heating wire, is defined as a length of the longitudinal axis. A width of the shape is defined as a dimension of the shape perpendicular to the longitudinal axis in-plane of the stretchable layer, in this case in x1-direction. A thickness of the shape is defined as a dimension of the shape perpendicular to the longitudinal axis out-of-plane of the stretchable layer, in this case in y1-direction. With the x1-direction being a direction corresponding to a width of the shape and the y1-direction being a direction corresponding to a thickness of the shape, the shape can be described based on a y-component, which is the projection of the shape on the y1z1-plane, and an x-component, which is the projection of the shape on the x1z1-plane, wherein at least the y-component of the shape is a substantially meandering pattern, for instance as shown in FIGS. 4-6.

The heating elements 5.2 of the second set of heating elements all extend parallel to each other in a z2-direction. The heating wires of the heating elements 5.2 each form an elongated shape around a longitudinal axis extending in z2-direction. A length of the shape, opposed to the length of the heating wire, is defined as a length of the longitudinal axis. A width of the shape is defined as a dimension of the shape perpendicular to the longitudinal axis in-plane of the stretchable layer, in this case in x2-direction. A thickness of the shape is defined as a dimension of the shape perpendicular to the longitudinal axis out-of-plane of the stretchable layer, in this case in y2-direction. With the x2-direction being a direction corresponding to a width of the shape and the y2-direction being a direction corresponding to a thickness of the shape, the shape can be described based on a y-component, which is the projection of the shape on the y2z2-plane, and an x-component, which is the projection of the shape on the x2z2-plane, wherein at least the y-component of the shape is a substantially meandering pattern, for instance as shown in FIGS. 4-6.

In the embodiment of FIG. 11, the heating elements 5.1 and 5.2 extend beyond the membrane 1 at both sides of the membrane 1. At the free ends of the heating elements 5.1, 5.2, connectors may be provided similar to the embodiments of FIGS. 7-10. The first set of heating elements 5.1 and the second set of heating elements 5.2 overlap allowing to address portions of the membrane 1 with either the heating elements 5.1, the heating elements 5.2 or a combination thereof.

As an example, when a subset of the heating elements 5.1 indicated using reference symbol SS1 is used to apply heat to the membrane 1 and simultaneously a subset of the heating elements 5.2 indicated using reference symbol SS2 is used to apply heat to the membrane 1, there are three different regions on the membrane 1. The regions I are the portions of the membrane 1 to which no heat is applied. Regions II are the portions of the membrane 1 to which only heat is applied by one of the subsets SS1 or SS2. Region III is the portion of the membrane 1 where the subsets SS1 and SS2 overlap and to which maximum heat is applied.

The first and second sets of heating elements may be provided in different layers of the membrane 1, e.g. adjacent layers at different distances from an upper surface of the membrane 1.

Although the reinforcement rods 3 in FIGS. 2 and 3 as well as the first and second sets of heating elements in FIG. 11 are indicated in a 90 degrees orientation relative to each other, other angles, e.g. 60 degrees and/or 120 degrees are also envisaged.

1. A stretchable layer for a reconfigurable mold comprising one or more embedded heating elements, each heating element having a heating wire for generating heat, characterized in that the heating wire forms an elongated shape around a longitudinal axis, said longitudinal axis extending in-plane of the stretchable layer, wherein a length of the shape corresponds to a length of the longitudinal axis, wherein a width of the shape is defined as a dimension of the shape perpendicular to the longitudinal axis in-plane of the stretchable layer, wherein a thickness of the shape is defined as a dimension of the shape perpendicular to the longitudinal axis out-of-plane of the stretchable layer, and wherein the shape is composed of x and y-components, in which x and y are directions in a Cartesian coordinate system with x being a direction corresponding to a width of the shape and y being a direction corresponding to a thickness of the shape, and in which the y-component of the shape is a substantially meandering pattern.

2. The stretchable layer according to claim 1, wherein the x-component of the shape is a meandering pattern.

3. The stretchable layer according to claim 2, wherein the x-component of the shape and the y-component of the shape are similar meandering patterns shifted relative to each other.

4. The stretchable layer according to claim 1, wherein the meandering pattern is a periodic function.

5. The stretchable layer according to claim 2, wherein the meandering patterns of the x-component and the y-component are periodic functions.

6. The stretchable layer according to claim 3, wherein the meandering patterns are periodic functions with a phase shift of substantially 90 degrees.

7. The stretchable layer according to claim 2, wherein both meandering patterns have the same amplitude.

8. The stretchable layer according to claim 1, wherein the longitudinal axis of the shape forms a straight line in-plane of the stretchable layer.

9. The stretchable layer according to claim 1, wherein the longitudinal axis of the shape meanders in-plane of the stretchable layer.

10. The stretchable layer according to claim 1, wherein the heating wires of the one or more embedded heating elements comprise spring steel.

11. The stretchable layer according to claim 1, wherein the one or more heating elements are configured to behave similar to extension springs.

12. (canceled)

13. (canceled)

14. (canceled)

15. An apparatus for making a three-dimensionally curved object, said apparatus comprising a membrane having a molding surface and a stretchable layer according to claim 1, and said apparatus further comprising an array of actuators for directly or indirectly acting on a surface opposite the molding surface of the membrane, wherein the apparatus is configured such that the membrane is configurable into a predetermined shape by individually adjusting an array of actuators acting on the surface opposite the molding surface of said membrane.

16. A method for fabricating a stretchable layer according to claim 1, said method comprising the following steps:
a. preparing a mold for the stretchable layer,
b. positioning one or more heating elements with the corresponding heating wires in a desired shape in the mold,
c. filling the mold with a resin to embed the one or more heating elements in the resin, and
d. curing the resin.

17. The method according to claim 16, wherein the stretchable layer is a stretchable layer according to claim 11, and wherein in step b. the one or more heating elements are positioned in the mold using a predetermined tension resulting in a predetermined extension of the one or more heating elements.

18. The stretchable layer according to claim 4, wherein the periodic function is sinusoidal.

19. The stretchable layer according to claim 5, wherein the periodic functions have the same spatial period.
